(19) United States
(12) Patent Application Publication
(10) Pub. No.: US 2010/0223662 A1
(43) Pub. Date: Sep. 2, 2010

(54) PROGRAMMABLE ELECTRONIC ACCESS CONTROL SYSTEM

(75) Inventors: Julia Vila Errandonea, Irun (Guipuzcoa) (ES); Mercedes Frances Pedraz, San Sebastian (Guipuzcoa) (ES)

Correspondence Address: EGBERT LAW OFFICES, 412 MAIN STREET, 7TH FLOOR, HOUSTON, TX, 77002, US

(73) Assignee: TALLERES DE ESCORIAZA, S.A., Irun (Guipuzcoa) (ES)

(21) Appl. No.: 12/681,730

(22) PCT Filed: Oct. 1, 2008
(86) PCT No.: PCT/ES2008/000618

§ 371 Date: Apr. 5, 2010

(30) Foreign Application Priority Data
Oct. 3, 2007 (ES) P200702697

(51) Int. Cl. H04L 9/32; G06F 21/00

(52) U.S. Cl. 726/6

(57) ABSTRACT

The invention relates to a programmable electronic access control system including: an updating unit which operates in conjunction with a central control unit and is provided with management software for global control of installation access. Access elements are associated with the entrance/exit routes, and a credential is associated with each system user. In addition, each updating unit includes means for the bi-directional transfer of data in relation to user credentials, and the central control unit. The updating unit transfers only the information concerning a particular user and the installation closure plan to the user credentials, while receiving information stored on the user credential relating to past events associated therewith, which have been transferred to each of the access elements.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to an installation access control system, which is based on electronic technology, allowing various user accreditation media and is managed by means of a computer program.

2. Description of Related Art Including Information Disclosed Under 37 CFR 1.97 and 37 CFR 1.98

A conventional access control system includes a central control unit, a series of access elements and access credentials.

In the central control unit, a software application or computer program is installed which manages the global control of installation access. In other words, it defines the installation users, the different installation access routes, the different time zones and inter-relates all these variables defining what is called the installation closure plan.

The access elements are associated with the installation entrance/exit routes for managing actual access via each of them. These access elements can be of different types, for example, locks, wall-mounted readers, or others capable of assuming this function.

Access credentials are individually associated with each user and allow different kinds of media (card, key, etc.). The function of these credentials is to be presented to the access element so that, in the event of the holder user being included in the permitted closure plan, he will be given authorised access to the installation.

In this field, there are control systems called “off line” due to there being no connection between the central control unit and the access element. In this type of system it is necessary to provide an external element which performs the function of portable programmer for configuring the access element according to the data programmed en the closure plan, and for collecting the events stored on said access element. This means that any interchange of information between the actions on the lock (for example, openings by different users carried out at different times, or the status of the batteries supplying the products) needs to be dumped into the central control unit by means of the aforesaid portable programmer which constitutes massive extra data storage. This is inconvenient in the case of large installations in which it is necessary to go round all the access routes with the portable programmer to keep the installation updated and to monitor events. This also means that the installation will be immediately updated only after each round of updating, but not in the intervals between two successive rounds. Additionally, updating by rounds requires a large amount of information to be stored on the user credentials, since it is not updated at the time of occurrence of the various events resulting from use of the system by multiple users.

Another inconvenience of “off line” control systems is that invalidation of a credential prior to the expiry date established when it is issued is subject to an updating round being carried out; so a lost credential could be used meanwhile, which represents a significant security failure.

### BRIEF SUMMARY OF THE INVENTION

The access control system proposed here is the result of reflection on the options offered by current technology in this regard. And current technology allows user credentials to have increasingly more information and to manage it with greater flexibility. Whatever the technology used for communication between the credential medium and the access element; such as RFID (radiofrequency identification) proximity, contact chip, etc. It is possible nowadays to store a certain level of information in a secure manner via powerful encryption systems and share it with peripheral systems in a bi-univocal manner by means of bi-directional communication.

The result of applying this to access control systems is that, developing suitable management elements and adapting the communication management of the different systems, it is possible to pass the necessary information from the central control unit to the user credential, store this information on the credential and finally pass it to the access element. In the same way, it would also be possible to pass information from the access element to the user credential, store this information on the credential and send it finally to the central control unit to be processed. Insofar as the application is for access control, all this circulation and storage of information needs to be done with a guarantee of total security and reliability.

Therefore, taking account of the above, the system proposed by the present invention in this regard includes an updating unit which operates in conjunction with a central control unit, provided with management software for global control of installation access, and with access elements associated with the entrance/exit routes for managing access via them, and with a credential associated with each system user, the updating unit of which has means for the bi-directional transfer of data with both the user credentials and the central control unit.

Another specific feature of the invention is that the updating unit transfers to the user credentials only the information concerning that user, while the updating unit receives from each user credential the information stored thereon relating to past events associated therewith on each of the access elements.

Another specific feature of the invention is that, in addition to the expiry information associated with each user credential, the updating unit also transfers to the user credentials a configurable temporary invalidity parameter included in the expiry period thereof.

Another specific feature of the invention is that the updating unit transfers to the central control unit the information taken from the user credentials, while it receives the information relating to the programmed installation closure access control plan current at any moment.

Another specific feature of the invention is that an updating unit will be associated with, at least, the main access routes, in conjunction with a program of the central control unit which requires the user credentials to be presented to the updating unit before being presented to the access element relating to this access route.

According to this constitution of the system proposed, the following can be achieved.

Using a network connection to the central control unit on which the parameters are established and the closure plan managed, of an installation, the updating unit is responsible for the bi-directional communication of the information required with the user credential. The updating unit identifies the user credential and stores on it the information corresponding to said user's closure plan. For its part, the information previously stored on the user credential which collects the past events on each of the access elements is transferred from the credential to the updater and from here to the central control unit to be processed.

Each time a user accesses an access route and presents his credential to the access element, once the user is recognised in the closure plan, the information passes from the credential to the access element so that it updates his closure plan if this is necessary. In its turn, the information stored on the access element (collected from events or occurrences) is transferred to the user credential and stored, and also opens or rejects.

Thus, when a user presents his credential to the updater, the installation information is updated (in both the closure plan and the status of the different elements of the installation), releasing itself from the credential memory.

With the aim of guaranteeing that the installation information is permanently updated, it is necessary to ensure that user credentials are submitted to the updater. This is achieved by associating a door control with the updater, generally linked to the main access routes, so that it is necessary to present the user credential to said updater in order to be able to access the installation. Therefore, if the user is in the installation closure plan and he will have automatically updated the system.

There is another function associated with the updater for guaranteeing that each user presents his credential and thereby updates the information: revalidation. In addition to the expiry information associated with every credential, there is a parameter configurable by the updater which obliges a user to present his credential from time to time. Otherwise this credential will remain invalid in the installation until it is presented to the updater.

This function of the invention has, among others, the following advantages:

Only the information associated with a specific user is stored on each of the user credentials, compared with other techniques which require the storage of a larger amount of information to cover access control. This means that the amount of memory remaining for storing events or changes of closure plan is much greater in the present invention. Also, for the same number of events collected, both transaction time and battery consumption are reduced in the current system in that the amount of information stored is less for covering the same function.

Besides guaranteeing that every user presents his credential to the updater and the installation information is automatically updated, the revalidation function guarantees the invalidity of a credential if it has been lost. In other systems a lost or stolen card could continue to be used in an installation with the consequent vulnerability of the system, whereas by means of the present invention, every time a credential is lost, it cannot be used in the installation until it is revalidated on the updater. At this point the management system would automatically cancel the credential, every time it has logged out of the installation.

With respect to Patent ES 2,183,739, with the system proposed it is sufficient to record the new credential for it to be possible to open the lock corresponding to which it has been given system access directly without needing to resort to a portable programmer.

Another advantage concerning the system proposed is that the credential considered can include data concerning another credential whose closure plan it is wished to modify, remove or add.

### BRIEF DESCRIPTION OF THE SEVERAL VIEWS OF THE DRAWINGS

For a better understanding of the nature of the invention, the attached drawings show a form of embodiment by way of purely illustrative and non-restrictive example.

FIG. 1 is a schematic representation of the access control system, according to the invention.

These figures include the following references:

1.—Updating unit

2.—Central control unit

3.—Access element

4.—User credential

### DETAILED DESCRIPTION OF THE INVENTION

With relation to the drawings and references listed above, the attached diagrams illustrate a form of preferred embodiment of the subject of the invention, with reference to a programmable electronic access control system including an updating unit (1) which operates in conjunction with a central control unit (2), provided with management software for global control of installation access, and with access elements (3) associated with the entrance/exit routes for managing access via them, and with a credential (4) associated with each system user. The updating unit (1) of which has means for the bi-directional transfer of data with both the user credentials (4), and the central control unit (2). The access elements (3) and user credentials (4) can be of different technologies; in the first case, it could be locks, wall-mounted readers, etc.; in the second case, cards, keys, etc.

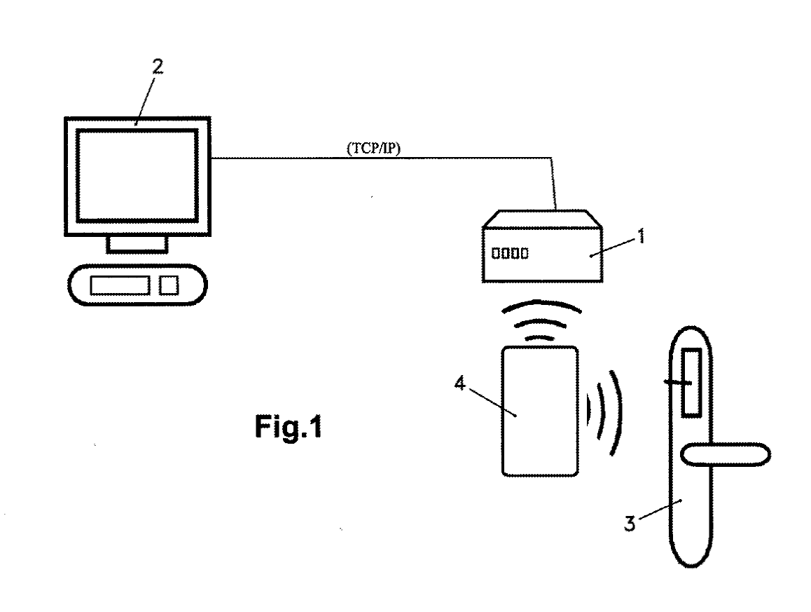

The line drawing in FIG. 1 illustrates this constitution of the recommended system, and the following specific features are also achieved: the updating unit (1) transfers to the user credentials (4) only the information concerning that user, while the updating unit (1) receives from each user credential (4) the information stored thereon relating to past events associated therewith on each of the access elements (3). In addition to the expiry information associated with each user credential (4), the updating unit (1) also transfers to the user credentials (4) a configurable temporary invalidation parameter included in the expiry period thereof; the updating unit (1) transfers to the central control unit (2) the information taken from the user credentials (4), while it receives the information relating to the programmed installation access closure control plan current at any moment. An updating unit (1) will be associated with, at least, the main access routes, in conjunction with a program of the central control unit (2) which requires the user credentials (4) to be presented to the updating unit (1) before being presented to the access element (3) relating to this access route.

Finally, the line drawing in FIG. 1 illustrates the operation described above, with the advantages also mentioned derived therefrom. By means of a network connection to the central control unit (2) on which the parameters are established and the closure plan managed, of an installation, the updating unit (1) is responsible for the bi-directional communication of the information required with the user credential (4). The updating unit (1) identifies the user credential (4) and stores on it the information corresponding to said user's closure plan, while it receives the information previously stored on the user credential (4), where the past events on each of the access elements (3) have been collected, this information being transferred from the user credential (4) to the updating unit (1) and from here to the central control unit (2) to be processed.

When a user accesses an access route and presents his user credential (4) to the access element (3), once the user is recognised in the closure plan, the information of the user credential (4) is passed to the access element (3), so that, if necessary, his closure plan is updated thereon. In its turn, the information stored on the access element (3) (collection of openings or internal access element statuses) is transferred to the user credential (4) and stored thereon.

When a user credential (4) is presented to the updating unit (1), the information relating to the installation is updated (in both the closure plan and the status of the different elements of the installation), releasing itself from the user credential memory (4).

To guarantee that the installation information is permanently updated, it is necessary to ensure that user credentials (4) are presented to the updating unit (1). To achieve this, a door control is associated with the updating unit (1), linked to the main access routes, so that it is necessary to present the user credential (4) to said updating unit (1) in order to be able to access the installation. Therefore, if the user is in the installation closure plan, he will have authorised access and he will have automatically updated the system.

The updating unit (1) has a function for guaranteeing that every user presents his user credential (4) and thereby updates the information: this function is called revalidation. In addition to the expiry information associated with every user credential (4), there is a parameter configurable by the updating unit (1) which obliges a user to present his user credential (4) from time to time. Otherwise, this user credential (4) will remain invalid in the installation until it is presented to the updating unit (1).

This function of the invention has, among others, the following advantages:

Only the information associated with a specific user is stored on each of the user credentials, compared with other techniques which require the storage of a larger amount of information to cover access control.

The amount of memory remaining for storing events or changes of closure plan is greater in the present invention.

For the same number of events collected, both transaction time and battery consumption are reduced in the current system in that the amount of information stored is less for covering the same function.

Besides guaranteeing that every user presents his credential to the updater and the installation information is automatically updated, the revalidation function guarantees the invalidity of a credential if it has been lost; so that a lost credential cannot be used in the installation until it is revalidated on the updater, in other words the management system would automatically cancel the credential, every time it has logged out of the installation.

An updating unit (1) or a general credentials editor validates a new credential (4) for temporary use so that, being inter-related with the access elements (3) validated on the central system (2), it is permitted access thereto without a portable programmer needing to be used. Likewise an updating unit (1) or a general credentials editor permits the entry of information relating to the cancellation of another credential (4) on the system when it is updated by the control unit (2).

Also an updating unit (1) or a general credentials editor permits the modification of information relating to another different credential corresponding to the closure plan data.

1. Programmable electronic access control system, characterised in that it includes an updating unit which operates in conjunction with a central control unit, provided with management software for global control of installation access, and with access elements associated with the entrance/exit routes for managing access via them, and with a credential associated with each system user, the updating unit of which has means for the bi-directional transfer of data with both the user credentials and the central control unit; the updating unit transfers to the user credentials only the information concerning that user and the installation closure plan while the updating unit receives from each user credential the information stored thereon relating to past events associated therewith which have been transferred to each of the access elements.

2. Programmable electronic access control system, according to claim 1, characterised in that, in addition to the expiry information associated with each user credential, the updating unit also transfers to the user credentials a configurable temporary invalidation parameter included in the expiry period thereof.

3. Programmable electronic access control system, according to claim 1, characterised in that the updating unit transfers to the central control unit the information taken from the user credentials, while it receives the information relating to the programmed installation access closure control plan current at any moment.

4. Programmable electronic access control system, according to claim 1, characterised in that an updating unit will be associated with, at least, the main access routes, in conjunction with a program of the central control unit which requires the user credentials to be presented to the updating unit to validate their corresponding access.

5. Programmable electronic access control system according to claim 1, characterised in that an updating unit or a general credentials editor validates a new credential for temporary use so that, being inter-related with the access elements validated on the central system, it is permitted access thereto without a portable programmer needing to be used.

6. Programmable electronic access control system according to claim 1, characterised in that an updating unit or a general credentials editor permits the entry of information relating to the cancellation of another credential on the system when it is updated by the control unit.

7. Programmable electronic access control system according to claim 1, characterised in that an updating unit or a general credentials editor permits the modification of information relating to another different credential corresponding to the closure plan data.
